(19) United States
(12) Patent Application Publication
(10) Pub. No.: US 2012/0005097 A1
(43) Pub. Date: Jan. 5, 2012

(54) DEVICE AND METHOD FOR HANDING OVER PRODUCTS PURCHASED ONLINE

(75) Inventor: Albert Bresser, Gouda (NL)

(73) Assignee: PTT POST HOLDINGS B.V., Hoofddorp (NL)

(21) Appl. No.: 13/140,943

(22) PCT Filed: Dec. 21, 2009
(86) PCT No.: PCT/NL09/50786

§ 371 Date: Sep. 21, 2011

(30) Foreign Application Priority Data
Dec. 19, 2008 (NL) 2002353

(51) Int. Cl. G06Q 30/00; H04L 9/00; G06Q 10/00

(52) U.S. Cl. 705/50; 705/337; 705/26.41

(57) ABSTRACT

Device for handing over an item to be delivered originating from a sender to be delivered to a recipient, includes a central processing unit, memories and an input device, wherein the processing unit is connected to the memory and to the input device, and the is set up to carry out:
the identifying of the item to be delivered;
the receiving via the input device of a delivery code from the recipient;
the obtaining of delivery data for the item to be delivered from a database on the basis of the identification, wherein the delivery data include a control code for handover;
the checking to determine whether the delivery code matches the control code of the obtained delivery data, and
if the delivery code matches the control code, the generating of a handover signal, or, if the delivery code does not match the control code, the generating of a rejection signal.

The invention relates to a device for handing over an item to be delivered originating from a sender to be delivered to a recipient. The invention furthermore relates to a method for handing over an item to be delivered originating from a sender to be delivered to a recipient.

Electronic communications are used to an increasing extent to purchase products.

Particularly the development of the Internet and the World Wide Web has led to an increase in the facility for a consumer to purchase online products. Here, the consumer communicates, for example, by means of a web browser with a web store offering products.

When an order is placed, a method is carried out according to the prior art which entails indicating the required product, specifying a delivery address and paying for the product.

The consumer chooses a product, provides the web store with data relating to the delivery address and makes a payment.

The payment for the product can be made in different ways, such as an online payment via a bank or an online payment using a credit card. It is also possible to make a payment in advance by means of a payment transfer via a bank account or by means of a deposit transfer.

Following receipt of the payment, the web store will transfer the product to a courier service which delivers the product to the specified delivery address.

This method has various disadvantages.

If the product is not received by the consumer at the delivery address for whatever reason, the courier service will return the product at a given moment to the web store, with the resulting disadvantage for the web store that the payment must be cancelled.

It is also possible that a delivery is actually made by the courier service, but the product does not reach the consumer, for example because the product is received by a third party.

It is also possible for a consumer to be dishonest and claim that he has not received the product.

One object of the invention is to provide a device which eliminates one or more of the aforementioned disadvantages.

The object is achieved by a device according to the preamble to Claim 1, comprising a central processing unit, memories and an input device, wherein the processing unit is set up to carry out:

identifying the item to be delivered;

receiving via the input device of a delivery code from the recipient;

obtaining delivery data for the item to be delivered from a database on the basis of the identification, wherein the delivery data comprise a control code for handover; checking to determine whether the delivery code matches the control code of the obtained delivery data, and, if the delivery code matches the control code, generating a handover signal, or, if the delivery code does not match the control code, generating a rejection signal.

In an advantageous manner, the invention enables the payment to be cancelled automatically if the consignment does not reach the consumer. A further achievement is that delivery can only be made to authorized persons who are in possession of the matching delivery code. Furthermore, fraudulent action is discouraged since only authorized persons are able to present a matching delivery code.

In one embodiment, the invention furthermore provides that the device also comprises a code, scanner to read in a machine-readable code, wherein the machine-readable code is attached to the item to be delivered, wherein the processing unit is connected to the code scanner, and wherein, in the identification, the processing unit is arranged to read in the machine-readable code and to identify the item to be delivered from the machine-readable code.

The use of a code scanner and machine-readable code enables a further automation of the delivery process.

In addition, in one embodiment, the invention provides for the device as described above, wherein the processing unit is arranged to store the result of the check to determine whether the delivery code matches the control code of the identified delivery data.

In one embodiment, the invention provides that the control code comprises an encrypted code and the processing unit is arranged to check whether the delivery code matches the encrypted code.

In a further embodiment, the invention provides that the encrypted code is a hash code.

In one embodiment, the invention provides that the delivery code is predefined during an ordering procedure for the item to be delivered and the control code is generated on the basis of the predefined delivery code.

In one embodiment, the invention provides that the database is located in the memory.

In a different embodiment, the invention provides that the database is located on a server and the processing unit is arranged to receive the delivery data from the server.

Furthermore, the invention relates to a method according to the preamble to claim 9, comprising identifying the item to be delivered; receiving a delivery code from the recipient; obtaining delivery data for the item to be delivered from a database on the basis of the identification, wherein the delivery data comprise a control code for handover; checking to determine whether the delivery code matches the control code of the obtained delivery data, and, if the delivery code matches the control code, the generating of a handover signal, or, if the delivery code does not match the control code, generating a rejection signal.

The invention also relates to a method for handing over an item to be delivered originating from a sender to be delivered to a recipient,

comprising a web portal server, a logistics server, a payment server and a device for handing over the item to be delivered, wherein the web portal server, the logistics server and the payment server are interconnected via a communications link, and wherein the logistics server and the device for handing over the item to be delivered are interconnected via a communications connection, wherein the device is arranged to carry out:

identifying the item to be delivered; receiving a delivery code from the recipient; obtaining delivery data for the item to be delivered from a database on the basis of the identification, wherein the delivery data comprise a control code for handover; checking to determine whether the delivery code matches the control code of the obtained delivery data, and, if the delivery code matches the control code, generating a handover signal, or, if the delivery code does not match the control code, generating a rejection signal.

The invention also relates to a computer program to be loaded by a device for handing over an item to be delivered originating from a sender to be delivered to a recipient, comprising a central processing unit, memories and an input device, wherein the processing unit is connected to the memory and to the input device, wherein the computer program, after being loaded, enables the processing unit to carry out:

identifying the item to be delivered;

receiving via the input device a delivery code from the recipient;

obtaining delivery data for the item to be delivered from a database on the basis of the identification, wherein the delivery data comprise a control code for handover;

checking to determine whether the delivery code matches the control code of the obtained delivery data, and

if the delivery code matches the control code, generating a handover signal, or, if the delivery code does not match the control code, generating a rejection signal.

Further embodiments according to the present invention are described in the subclaims.

The invention will be explained in detail below with reference to a number of drawings, in which example embodiments of the invention are shown. The drawings are intended solely as an illustration of the aims of the invention and not as a limitation of the inventive concept, which is defined by the attached claims.

In the drawings:

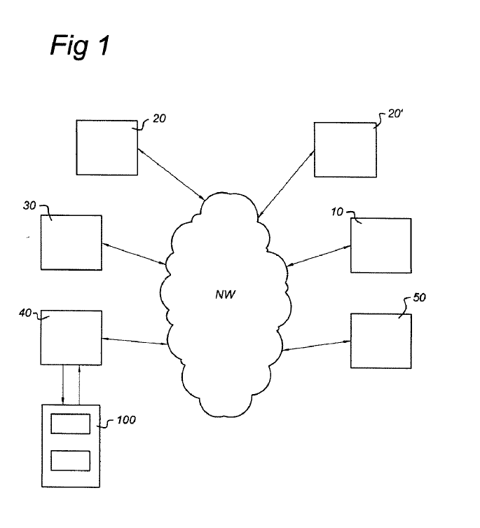

FIG. 1 shows a system which uses a device according to the invention;

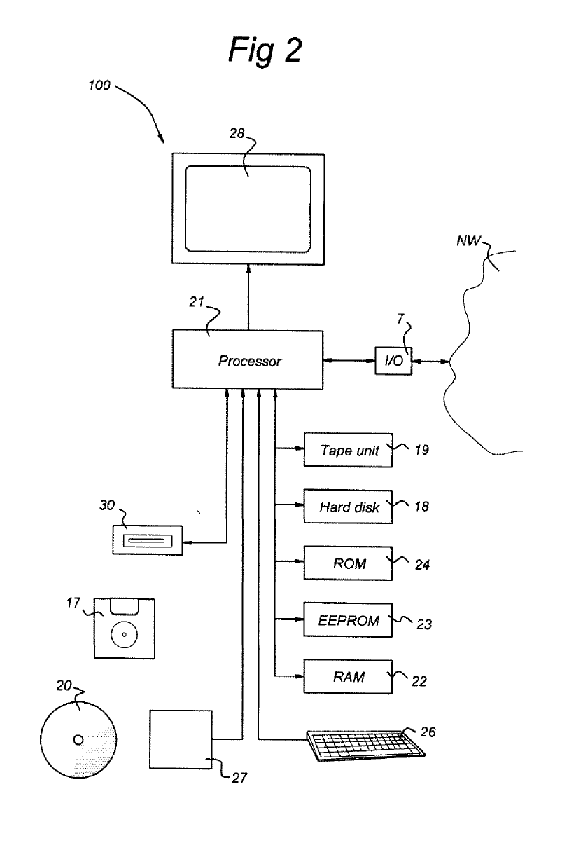

FIG. 2 shows a device for delivering goods according to an embodiment of the invention;

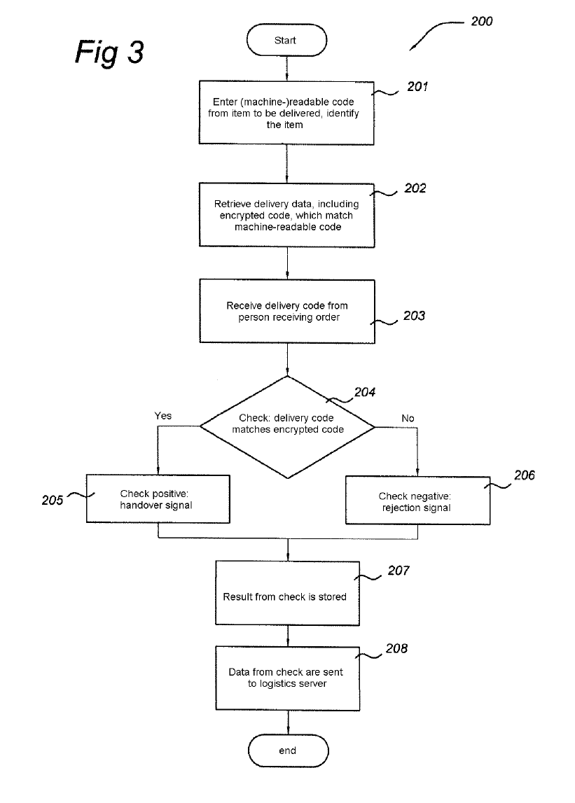

FIG. 3 shows a flow diagram of a method carried out by the delivery terminal;

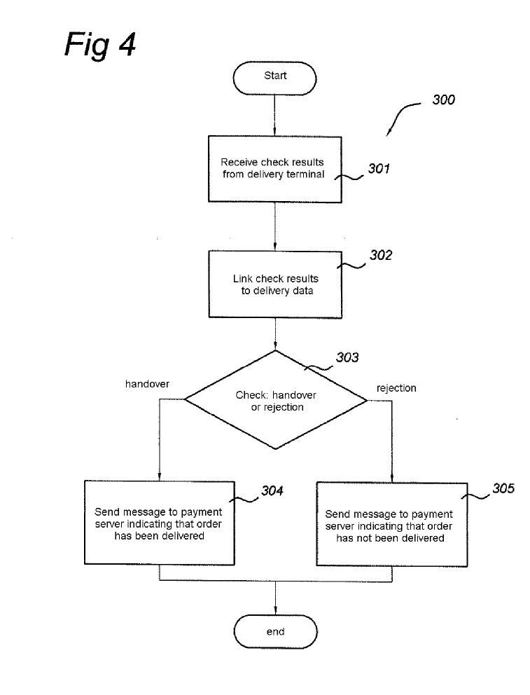

FIG. 4 shows a flow diagram of a method carried out by the logistics server;

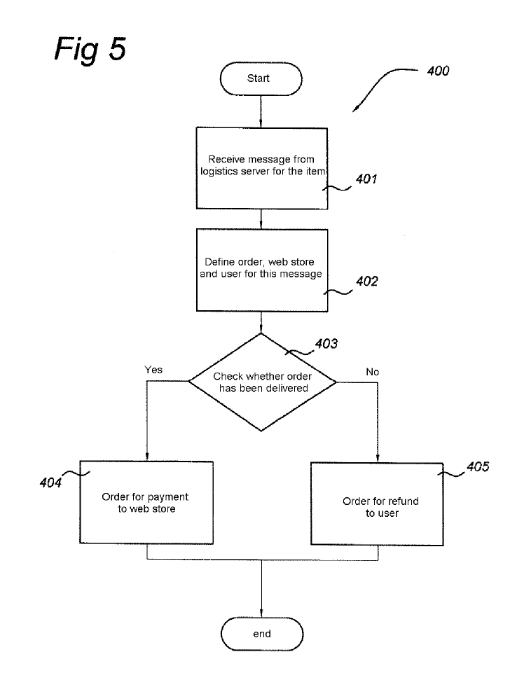

FIG. 5 shows a flow diagram of a method carried out by the payment server;

FIG. 1 shows a system 1 which uses a device according to the invention;

The system 1 uses a network NW and comprises a web portal server 30, a logistics server 40 and a payment server 50.

The network NW is a network set up for data communications and may comprise a large number of interconnected wired and/or wireless networks, such as, for example, the Public Switched Telephone Network (PSTN), or any other given network. For example, interconnected networks of this type may be a Local Area Network (LAN) or a Wide Area Network (WAN).

The web portal server 30, the logistics server 40 and the payment server 50 are computer systems which are known to the person skilled in the art.

Other computer systems are connected via a communications connection to the network NW, which can communicate via the connection with the system 1. Other computer systems of this type comprise computer systems of one or more web stores, (two of which are indicated by reference numbers 20, 20′) and computer systems of consumers (one of which is indicated by reference number 10).

Furthermore, the system 1 comprises at least one device for delivery 100, referred to below as the delivery terminal. The at least one delivery terminal 100 is connected via a communications connection to the logistics server 40.

The communications connection between the at least one delivery terminal 100 and the logistics server 40 can be established via the network NW. Alternatively, this communications connection may comprise an application-oriented connection outside the network NW.

The system 1 shown is set up to process electronic/online orders for products. A user sets up a connection via his computer 10 with a web store of his choice (for example the web store 20) to order a product from this web store. At a given moment, the user has selected a product and the actual order is placed. In a known manner, the web store computer 20 will communicate with the user via his computer 10 in order to register the order. A registration of this type includes the product which is chosen and the delivery address which is to be used (possibly the billing address also). The web store computer 20 then presents a choice for payment. Along with other forms of payment, this choice includes a facility to pay cash on delivery, for example, designated as Online Cash On Delivery.

According to one embodiment of the invention, if the user chooses to pay cash on delivery, the web store computer 20 sets up a connection between the computer 10 of the user and the web portal server 30 of the system 1.

The manner in which this connection is set up by the web store computer 20, wherein a reference to the associated order is also sent, is known to the person skilled in the art.

The reference comprises at least the name and address data relating to the user (the recipient), the data relating to the order and to the web store (the sender).

The web portal server 30 and the computer 10 of the user are interconnected, wherein the name and address data from the order reference which is also sent are used as order data. The computer of the user is then referred through to a payment server 50, wherein a connection is set up between the computer 10 of the user and the payment server 50. In setting up the connection in a manner known to a person skilled in the art, a reference is also sent to the payment server 50 in order to be able to identify the order and the payment. The user then sends a payment order relating to the order via the computer 10 to the payment server 50. With the payment order, the payment server 50 effects a payment to a suspense account.

The payment server then sends a message to the web store computer 20 indicating that the payment order has been carried out. The web store computer 20 can then instigate the despatch process for the ordered product. The ordered product is provided here with a label with at least the name and address data of the user and a machine-readable code identifying the order. This is carried out by logistics software used by the web store.

Similarly, on completion of the payment order, the payment server 50 refers the computer 10 of the user back to the web portal server 30. The web portal server obtains information from the payment server indicating that the payment order has been carried out.

The web portal server 30 then carries out a procedure, wherein a delivery code is defined in communication with the computer 10. The delivery code may be generated in that the user himself enters a delivery code and sends it to the web portal server 30. Alternatively, the web portal server 30 may generate a delivery code and send it to the user of the computer 10.

In an alternative embodiment, the web portal server 30 is set up to send the delivery code to a telephone of the user of the computer 10 by means of an SMS message. Alternatively or additionally thereto, the web portal server 30 can be set up to send the delivery code to an e-mail address of the user of the computer 10. The telephone number and/or e-mail address can be exchanged in the communication process between the web portal server and the computer 10.

As an alternative to the transmission of the delivery code by the web portal server 30, the logistics server 40 can be set up, having been controlled from the web portal server 30, to send the delivery code to a telephone of the user of the computer 10 by means of an SMS message. Alternatively or additionally thereto, the logistics server 40 can also be set up to send the delivery code to an e-mail address of the user of the computer 10. The telephone number and/or e-mail address can be exchanged in the communication process between the logistics server 40 and the computer 10.

The delivery code is retained by the user.

The web portal server 30 or the logistics server 40 is set up, following the definition of the delivery code, to generate a control code which matches the delivery code.

This control code comprises an encrypted code. In one embodiment, the encrypted code is a hash code.

The web portal server 30 can store reference data for the order (obtained from the web store computer 20) and the control code as delivery data.

Furthermore, the web portal server 30 is set up to send the delivery data (the reference data for the order and the control code) to the logistics server 40.

The logistics server 40 is set up to perform the logistics process by interworking with the delivery terminal 100.

To perform the logistics process, the logistics server 40 sets up delivery data for the order described above. The logistics server 40 sends the previously defined delivery data to the delivery terminal 100.

FIG. 2 shows a delivery terminal for delivering goods according to an embodiment of the invention;

The delivery terminal 100 comprises a central processing unit 21 with peripheral equipment. The central processing unit 21 is connected to memory means 18, 19, 22, 23, 24 which store instructions and data, one or more read-in units 30 (to read, for example floppy disks, CD-ROMs and DVDs, etc.), a keyboard 26 as an input device, and, at least as an output device, a monitor 28. Furthermore, the delivery terminal 100 is equipped with a barcode scanner to read in a barcode or a different type of machine-readable code. Additionally or alternatively, other input units, such as a touchscreen, and also other output devices can be provided.

Furthermore, the central processing unit 21 is provided with a network adapter 7 for data communication with the network NW.

The memory means shown in FIG. 2 comprise a RAM 22, (E)EPROM 23, ROM 24, tape unit 19, and hard disk 18. However, more and/or other memory units may be provided, as will be obvious to a person skilled in the art. Furthermore, if necessary, one or more of these units may be located remotely from the central processing unit 21.

The central processing unit 21 is shown as a single unit, but may also comprise various different processing units which operate in parallel or are controlled by one central unit, wherein the processing units may be located remotely from one another, as will be known to persons skilled in the art in this technical domain.

In one embodiment, the delivery terminal 100 is a portable The delivery terminal 100 is set up to receive the predefined delivery data and store them in its memory.

In a known manner, the ordered product is delivered from the web store to the courier service which uses the delivery terminal. The ordered product is provided with a machine-readable code which identifies the order and links it to the delivery data for this order, as stored in the delivery terminal.

FIG. 3 shows a flow diagram 200 for an embodiment of a method which can be carried out by the delivery terminal.

At a given time, the order is delivered to the user.

In an action 201, the machine-readable code of the order is entered into the delivery terminal 100 in order to identify the item to be delivered. To do this, the delivery terminal 100 is set up to read the machine-readable code on the ordered product, for example by means of the barcode reader/scanner. Alternatively, a code readable by a person can be entered by means of the keyboard.

The item to be delivered is then identified from the entered code.

Hereafter, in action 202, the delivery terminal retrieves the delivery data for the ordered product, including the control code for the order, on the basis of the identification from a database.

In one embodiment, the database is located in the memory of the delivery terminal. In this case, the logistics server 40 makes the delivery data available to the delivery terminal prior to the delivery as part of a list of different items to be delivered, wherein the list relates to a previously defined delivery sequence of a plurality of items to be delivered.

In a different embodiment, the database is located remotely in the logistics server. In this case, the delivery terminal requests the logistics server to send the delivery data of the identified item to be delivered via a wireless communications link. The logistics server is set up here to transmit the delivery data in a wireless manner at the time when the delivery terminal requests it, for example at the time when delivery of the item takes place.

Then, in action 203, the delivery terminal receives the previously defined delivery code from the user via the keyboard or a different suitable input device such as a touchscreen. To do this, the delivery terminal is set up to receive, via an input, a delivery code from the person who receives the ordered product (for example the user of the computer 10).

Thereafter, in action 204, the processing unit of the delivery terminal carries out a control check to determine whether the entered, previously defined delivery code matches the control code previously retrieved from the memory in the delivery data for the ordered product. To do this, the processing unit runs a suitable algorithm.

In one example embodiment, the processing unit determines whether the previously defined delivery code matches the hash code which is used as the encrypted code.

If the control check indicates that the entered delivery code and the control code match one another, the processing unit of the delivery terminal generates a handover signal in action 205 indicating that the ordered product should be handed over. In this case, the courier service hands the order over to the recipient. A further requirement here may be that the recipient provides a signature as additional proof of receipt.

If the control check reveals that the entered delivery code and the encrypted code do not match one another, the processing unit of the delivery terminal generates a rejection signal in action 206 indicating that the ordered product should not be handed over. In this case, the courier service does not hand over the order to the recipient.

Following the generation of the handover signal in action 205 or the rejection signal in action 206, the processing unit of the delivery terminal stores the result of the control check in action 207 in the memory with the matching delivery data of the order.

Thereafter, in action 208, the processing unit of the delivery terminal carries out instructions to send the results of the control check to the logistics server 40, wherein an indication of the matching order/and or delivery data is given in such a way that the logistics server can link the results to the delivery data previously set up by the logistics server.

The delivery terminal repeats the above method for each order that has been processed.

The method for the delivery terminal ends hereafter.

It will be obvious that, in action 206, if the delivery code and the encrypted code do not match one another, the person who receives the order may make a number of attempts, for example three attempts in total, to enter the correct delivery code. This is not shown here for the clarity of the drawing. In one embodiment, for example following three incorrect attempts, the delivery data relating to the order concerned are blocked, so that handover is no longer possible. The ordered product can be offered again to the recipient, in the event that the recipient was not present during an earlier offering, within the aforementioned method 200.

Furthermore, it should be noted that the control code or encrypted code is not visible on the delivery terminal. Also, the delivery terminal contains no indication or, in any event, no accessible indication, of the delivery code. In this way, the risk of incorrect delivery or fraud is reduced.

As a result of the method 200 outlined above, a handover of an order can only take place if a recipient of the order knows the handover code. The possibility of an incorrect delivery being made (to the wrong person) is thereby reduced. The method outlined above also offers the advantage that reliable proof of delivery is provided by using a handover code.

In the embodiment in which the delivery terminal comprises a touchscreen, the method can provide that the recipient, in addition to the handover code, also enters a signature via the touchscreen, wherein the entered signature is stored with the matching delivery data.

FIG. 4 shows a flow diagram 300 for a method which can be carried out by the logistics server 40 when receiving the control check results from the delivery terminal 100.

In action 301, the logistics server 40 of the delivery terminal 100 receives the results of the control check, wherein the results comprise an indication of the matching order and/or delivery data.

In action 302, the processing unit of the logistics server carries out instructions with which the received results from the control check can be linked to the delivery data previously set up by the logistics server.

In action 303, the processing unit of the logistics server 40 checks the received result from the control check for the matching order and/or delivery data.

If the result of the control check is positive (the delivery code matches the encrypted code and the order is delivered), the logistics server 40 determines, in action 304, that the order has taken place (proof of delivery) and the logistics server 40 sends a message to the payment server 50 indicating that payment has been made. This message comprises a reference to the order data (i.e. the delivery data).

If the result of the check is negative (the delivery code does not match the encrypted code and the order has not been delivered, or the order could not be delivered), the logistics server 40 determines, in action 305, that the order has not taken place and the logistics server 40 sends a message to the payment server 50 indicating that no payment has been made. This message comprises a reference to the order data (i.e. at least the delivery data).

The logistics server repeats the above method for each order for which data are received from the delivery terminal.

The method for the logistics server 40 ends hereafter.

FIG. 5 shows a flow diagram 400 for a method which can be carried out by the payment server 50 when receiving the message(s) from the logistics server 40.

In action 401, the processing unit of the payment server 50 receives the message from the logistics server.

In action 402, the processing unit processes the message, wherein the web store and the user to which the order relates are identified.

In action 403, the processing unit checks whether the order has actually been delivered by referring to the message from the logistics server. As explained above, the message from the logistics server is linked to the control check by the delivery terminal when the order is offered to the recipient.

In action 404, if the result of the check is positive (the delivery code matches the encrypted code and the order has been delivered), the processing unit of the payment server 50 carries out instructions for a payment order to the web store, wherein the payment for the order which is linked to the delivery data is made and is transferred from the suspense account to an account of the web store.

In action 405, if the result of the check is negative (the delivery code does not match the encrypted code and the order has not been delivered, or the order could not be delivered), the processing unit of the payment server carries out a payment order, wherein the payment for the original order which is linked to the delivery data is paid back from the suspense account to the user. The payment server can then send a message to the web store indicating that the payment has not been made.

The payment server repeats the above method for each order for which data have been received from the logistics server.

The method for the payment server ends hereafter.

Incorrect delivery is prevented by means of the methods described in FIGS. 3, 4 and 5. Unjustified payment as a result of incorrect delivery is also prevented. Furthermore, the problem that the payment from the customer/user must be cancelled by the web store if an order is returned to the web store is solved.

The order can be cancelled without the need to carry out a financial administrative process in the web store.

The described method with the validation process can be used in a payment method outside the system, for example in a payment by means of a credit card directly to the web store. The method described above offers the advantage that in this case “charge back” fraud can be prevented.

In addition, both the delivery terminal and the system simplify the processing of the order between the web store and its customer. The web store will be able to deliver with confidence when the payment order has been sent to the payment server. The customer will be reassured that his payment will not be made to the web store until he has received the ordered product.

Alternative and equivalent embodiments of the present invention are conceivable within the inventive concept, of a type that will be obvious to a person skilled in the art. The inventive concept is only restricted by the attached claims.

1. Device for handing over an item to be delivered originating from a sender to be delivered to a recipient, comprising a central processing unit (21), memories (18, 19, 22, 23, 24) and an input device (26), wherein the processing unit is connected to the memory and to the input device, wherein the processing unit is set up to carry out:
the identifying of the item to be delivered;
the receiving via the input device of a delivery code from the recipient;
the obtaining of delivery data for the item to be delivered from a database on the basis of the identification, wherein the delivery data comprise a control code for handover;
the checking to determine whether the delivery code matches the control code of the obtained delivery data, and
if the delivery code matches the control code, the generating of a handover signal, or, if the delivery code does not match the control code, the generating of a rejection signal,
wherein the database is located on a server and the processing unit is set up to receive the delivery data from the server.

2. Device according to claim 1, wherein the device furthermore comprises a code scanner to read in a machine-readable code, wherein the machine-readable code is attached to the item to be delivered,
wherein the processing unit is connected to the code scanner, and
wherein, in the identification, the processing unit is set up to read in the machine-readable code and to identify the item to be delivered from the machine-readable code.

3. Device according to claim 1, wherein the processing unit is set up to store the result of the check to determine whether the delivery code matches the control code of the identified delivery data.

4. Device according to claim 1, wherein the processing unit is set up to send the result of the check to determine whether the delivery code matches the control code of the obtained delivery data to a logistics server.

5. Device according to claim 1, wherein the control code comprises an encrypted code and the processing unit is set up to check whether the delivery code matches the encrypted code.

6. Device according to claim 5, wherein the encrypted code is a hash code.

7. Device according to claim 1, wherein the delivery code is predefined during an ordering procedure for the item to be delivered and the control code is generated on the basis of the predefined delivery code.

8. Device according to claim 1, wherein the database is located in the memory.

9. Method for handing over an item to be delivered, originating from a sender to be delivered to a recipient, comprising:
the identifying of the item to be delivered;
the receiving of a delivery code from the recipient;
the obtaining of delivery data for the item to be delivered from a database on the basis of the identification, wherein the delivery data comprise a control code for handover;
the checking to determine whether the delivery code matches the control code of the obtained delivery data, and
if the delivery code matches the control code, the generating of a handover signal, or, if the delivery code does not match the control code, the generating of a rejection signal,
wherein the database is located on a server and the method comprises: the receiving of the delivery data from the server.

10. Method according to claim 9, wherein the identification comprises:
the reading in of a machine-readable code, wherein the machine-readable code is attached to the item to be delivered,
and the determining from the machine-readable code of the identification of the item to be delivered.

11. Method according to claim 9, furthermore comprising the transmission to a logistics server for the processing of the delivery of the item, of the result of the check to determine whether the delivery code matches the control code of the identified delivery data.

12. Method according to claim 9, wherein the control code comprises an encrypted code and the check entails the checking to determine whether the delivery code matches the encrypted code.

13. Method according to claim 9, comprising the pre-definition of the delivery code during an ordering procedure for the item to be delivered, wherein the control code is generated on the basis of the predefined delivery code.

14. System for handing over an item to be delivered, originating from a sender to be delivered to a recipient,
comprising a web portal server (30), a logistics server (40), a payment server (50) and a device (100) for handing over the item to be delivered,
wherein the web portal server, the logistics server and the payment server are interconnected via a communications connection (NW), and wherein the logistics server and the device for handing over the item to be delivered are interconnected via a communications connection,
wherein the device is set up to carry out:
the identifying of the item to be delivered;
the receiving of a delivery code from the recipient;
the obtaining of delivery data for the item to be delivered from a database on the basis of the identification, wherein the delivery data comprise a control code for handover;
the checking to determine whether the delivery code matches the control code of the obtained delivery data, and
if the delivery code matches the control code, the generating of a handover signal, or, if the delivery code does not match the control code, the generating of a rejection signal,
wherein the database is located on a server and the device is set up to receive the delivery data from the server.

15. System according to claim 14, wherein the web portal server (30) is set up to define order data of the recipient of the item to be delivered, wherein the web portal server is furthermore set up to carry out the definition of the delivery code, and to generate the control code which matches the delivery code.

16. System according to claim 14, wherein the device (100) is set up to transmit the result of the check to determine whether the delivery code matches the control code of the identified delivery data to the logistics server to carry out the delivery process.

17. System according to claim 14, wherein the logistics server (40) is set up to supply the delivery data to the device (100).

18. System according to claim 17, wherein the logistics server (40) is set up to receive the results of the check, to link the received results of the check with the delivery data previously supplied by the logistics server, and to send a message to the payment server (50), wherein, depending on the result of the check, the item to be delivered is or is not delivered.

19. System according to claim 18, wherein the payment server (50) is set up to receive a payment order from the recipient, wherein a payment is made to a suspense account; to receive the message from the logistics server (40) indicating whether the item to be delivered has or has not been delivered, and, on the basis of that message, to effect an order for payment from the suspense account to the sender if the item to be delivered has been delivered, or an order for refund from the suspense account to the recipient if the item to be delivered has not been delivered.

20. Computer program to be loaded by a device for handing over an item to be delivered originating from a sender to be delivered to a recipient, comprising a central processing unit (21), memories (18, 19, 22, 23, 24) and an input device (26), wherein the processing unit is connected to the memory and to the input device, wherein the computer program, after being loaded, enables the processing unit to carry out:
the identifying of the item to be delivered;
the receiving via the input device of a delivery code from the recipient;
the obtaining of delivery data for the item to be delivered from a database on the basis of the identification, wherein the delivery data comprise a control code for handover;
the checking to determine whether the delivery code matches the control code of the obtained delivery data, and
if the delivery code matches the control code, the generating of a handover signal, or, if the delivery code does not match the control code, the generating of a rejection signal,
wherein the database is located on a server and the processing unit is set up to receive the delivery data from the server.

21. A computer-readable medium provided with a computer program according to claim 20.
